(19) United States
(12) Patent Application Publication
(10) Pub. No.: US 2007/0129041 A1
(43) Pub. Date: Jun. 7, 2007

(54) Receiver

(75) Inventors: Akio Yokoyama, Osaka (JP); Manabu Ookubo, Shiga (JP); Masayuki Ozasa, Kyoto (JP); Takao Soramoto, Kyoto (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/605,320

(22) Filed: Nov. 29, 2006

(30) Foreign Application Priority Data
Dec. 2, 2005 (JP) 2005-349108

(51) Int. Cl. H04B 1/18

(52) U.S. Cl. 455/280

(57) ABSTRACT

An intermediate-frequency signal from a frequency mixer is subjected to channel selection by a band-pass filter. Then an output signal from the band-pass filter is subjected to analog-to-digital conversion by an analog-to-digital converter on a predetermined sampling frequency. An anti-aliasing filter is provided at a stage previous to the analog-to-digital converter. The anti-aliasing filter includes notch filters and attenuates signals with frequencies which are higher and lower than a frequency which is an integral multiple of the sampling frequency by the intermediate frequency.

### BACKGROUND OR THE INVENTION

1. Field of the Invention

The present invention relates to a receiver which includes a frequency mixer which generates an intermediate-frequency signal and sampling circuits such as an AD converter which digitizes the intermediate-frequency signal and a switched capacitor circuit. More particularly, the invention relates to an intermediate-frequency circuit including an active filter which implements the function of preventing unwanted aliasing signals which occur at the frequency mixer and so on. And furthermore, the invention relates to a receiver, such as an AM/FM radio receiver, which includes an anti-aliasing filter acting at the time of discretization of the intermediate-frequency (IF) signal.

2. Background Art

FIG. 3 is a block diagram of an example of a configuration for a conventional superheterodyne AM/FM radio receiver. In FIG. 3, a RF filter 1 removes unwanted signals from an input RF signal to take a desired signal out. The RF signal from the RF filter 1 is amplified by the variable gain amplifier 2. Then the amplified signal is mixed with a local oscillator frequency signal from an oscillator 4 by a frequency mixer 3 and converted to an intermediate-frequency signal.

An IF channel filter 6C of FIG. 3 has the function of removing unwanted signals from an output signal from the frequency mixer 3 to take only a desired intermediate-frequency signal out. The IF channel filter 6C is provided by using an external passive component such as a ceramic filter in the main. The output signal from the IF channel filter 6C passes through an intermediate-frequency amplifier (IF amplifier) 7 and, thereafter, is converted to a base band signal by an IF detector 8.

The term channel refers to a frequency band assigned to one user under a certain communication standard; the IF channel filter 6C has the function of selecting a certain one from among various frequency bands. For example, in a GSM Standard, since a channel frequency band is 200 kHz, the IF channel filter 6C selects a frequency band of an intermediate frequency ±200 kHz. In addition, in an AM radio receiver, the IF channel filter selects a frequency band of an intermediate frequency ±3 kHz.

Then the output signal (base band signal) from the IF detector 8 is sent to an automatic gain control circuit (AGC) 9 to detect its amplitude; gain control voltages are fed from the automatic gain control circuit 9 to the variable gain amplifier 2 and the IF amplifier 7 such that the amplitude of the base band signal becomes constant. This means that the gains of the variable gain amplifier 2 and the IF amplifier 7 are concurrently controlled with the gain control voltages such that suitable dynamic ranges are maintained at the amplifiers and the filter.

The portion 10 enclosed with a broken line other than the RF filter 1 and the IF channel filter 6C is an integrated block. The base band signal from the IF detector 8 is sent to an AD converter 12B through an anti-aliasing filter 11C which suppresses an aliasing frequency.

As described above, in conventional AM/FM radio receivers, base band signals have been subjected to AD conversion at the time of the digitalization of signals and hence, the anti-aliasing filter 11C is disposed at a stage previous to the AD converter 12B.

In a case where when the sampling frequency used at the AD converter 12B is fs Hz, an input signal is sufficiently attenuated to a frequency which is up to half the sampling frequency fs, aliasing noise does not occur. Because of this, as the anti-aliasing filter 11C, a low-pass filter has been generally used which passes signals whose frequency bands are within a passing band and sufficiently attenuates signals with frequencies which are higher than half the sampling frequency fs. In this case, if the sampling frequency fs has been able to be set high, it has been possible to heighten the ratio of the passing band frequency of the anti-aliasing filter to its blocking band frequency, design the anti-aliasing filter 11C relatively easily, and include the filter 11C in an integrated circuit.

However, with further miniaturization of semiconductor elements, it has become possible in recent years to conduct digital processing at low cost with high precision. Because of this, in recent AM/FM radio receivers (digital receivers), an intermediate-frequency signal is subjected to AD conversion instead of base band signal, the digitized intermediate-frequency signal is subjected to digital processing (digital detection processing or the like) at a digital signal processor (DSP) 13, and the detected signal is sent to the automatic gain control circuit 9 as shown in FIG. 4. By reason of that, an IF channel filter 6A is disposed between the frequency mixer 3 and the IF amplifier 7, and an anti-aliasing filter 11D and an AD converter 12A are disposed between the IF amplifier 7 and the digital signal processor 13 having the detecting function. And further, a frequency divider (DIV) 5 is disposed between the oscillator 4 and the frequency mixer 3. The portion 10A enclosed with a broken line is an integrated block.

An example of such a configuration is shown in Non-Patent Reference 1 (“10.7-MHz IF-to-Baseband EA A/D Conversion System for AM/FM Radio Receiver”, IEEE Journal of Solid-State Circuits, Vol. 35, No. 12, December, 2000).

Incidentally, various unwanted signals, as well as a desired channel signal, are fed to the frequency mixer 3. FIG. 5 is a block diagram of a digital receiver and FIG. 6 shows frequency spectra formed when a desired wave and interference waves have been simultaneously fed to the digital receiver. In FIG. 5, letter symbol V_{RFX} denotes an input RF signal, letter symbol V_{RF} denotes a desired received signal (desired wave), letter symbols V_{URF1} and V_{URF2} denote two unwanted signals (interference waves), letter symbol V_{LO} denotes a local signal, and letter symbol Vout denotes an output signal from the frequency mixer 3. The relationships between these signals are expressed by the following equations:
V_{RFX}=V_{RF}+V_{URF1}+V_{URF2}
V_{RF}=A_{RF} cos (ω_{LO}t+ω_{IFD}t)
V_{URF1}=A_{URF1} cos (ω_{LO}t−ω_{IFD}t+ωₛt)
V_{URF2}=A_{URF2} cos (ω_{LO}t+ω_{IFD}t+ωₛt)
V_{LO}=cos (ω_{LO}t)
Vout=cos (ω_{IFD}t)+cos (ωₛt−ω_{IFD}t)+cos ((ωₛt−ω_{IFD}t)
Where letter symbol ω_{LO} denotes an angular frequency corresponding to a local frequency, letter symbol ω_{IFD} denotes an angular frequency corresponding to an intermediate frequency, letter symbol ωₛ denotes an angular frequency corresponding to a sampling frequency, letter symbol A_{RF} denotes the amplitude of the desired received signal, and letter symbols A_{URF1} and A_{URF2} denote the amplitudes of the unwanted signal.

FIG. 6 shows the frequency spectrum of an input signal to the frequency mixer 3 and the frequency spectrum of an IF output signal Vout from the frequency mixer 3. In FIG. 6, letter symbol f_{RF} denotes the frequency of the desired received signal, letter symbol f_{LO} denotes the frequency of the local signal, letter symbols f_{IF}, f_{IFD}, and f_{IFU} denote intermediate frequencies, letter symbol f_{IM} denotes the frequency of an image signal, and letter symbols f_{URF1} and f_{URF2} denote the frequencies of the unwanted signals. The relationships between the above frequencies are expressed by the following equations:
f_{RF}=f_{LO}+f_{IF}
f_{IM}=f_{LO}−f_{IF}
f_{IF}=f_{IFD}=f_{IFU}
f_{URF1}=f_{LO}+fₛ−f_{IF}
f_{URF2}=f_{LO}+fₛ+f_{IF}
From the above equations, it can be seen that there are the frequency difference fₛ−f_{IF} between the frequency f_{URF1} of the unwanted signal and the local frequency f_{LO} and the frequency difference fₛ+f_{IF} between the frequency f_{URF2} of the unwanted signal and the local frequency f_{LO}. The frequency differences fₛ−f_{IF} and fₛ+f_{IF} bring about aliasing signals in the output signal Vout from the frequency mixer 3.

That is, in the reception-type frequency mixer 3, when a RF signal with a frequency (f_{LO}+fₛ+f_{IF}) which is higher than the local frequency f_{LO} by the sum of the sampling frequency fₛ and the intermediate frequency f_{IF} and a RF signal with a frequency (f_{LO}+fₛ−f_{IF}) which is higher than the local frequency f_{LO} by the difference between the sampling frequency fₛ and the intermediate frequency f_{IF}, as well as the RF signal with the frequency f_{RF} to be essentially received, are present as the input of the frequency mixer 3, aliasing signals with frequencies fₛ+f_{IF} and fₛ−f_{IF} appear in the output signal from the frequency mixer 3 as shown in FIG. 7A. Since such an output signal becomes the input of the AD converter 12A, aliasing noise is produced and interference resulting from the aliasing signals occurs, thereby the reception quality of the receiver degrades. Because of this, as in the case of the AD conversion conducted on the base band, there has generally been a need to add to the input portion of the AD converter 12A a low-pass filter (anti-aliasing filter) which removes unwanted signals with frequencies of up to half the sampling frequency fₛ.

However, in order to prevent aliasing from occurring in radio receivers and so on, there is a need to attenuate interference waves so as to become lower than a desired wave in amplitude by 150 dB or more for the purpose of sufficiently maintaining their reception sensitivity. On account of this, as shown in FIG. 7B, sufficient attenuation has not been done by using an external passive filter alone, and therefore an anti-aliasing filter has had to be newly added to them. Such an anti-aliasing filter newly added refers to a filter which is required to attenuate signals with frequencies which are up to half an AD conversion frequency fₛ to a value determined by the resolution of the AD converter required.

Since the intermediate frequency heightens considerably in general, the sampling frequency heightens and the considerable amount of attenuation must be secured until frequencies decreases to half the AD conversion frequency fₛ. For these reasons, the anti-aliasing filter is difficult to design and hence, an external filter has been used. However, the use of such an external filter raises the production cost of receivers and the density of printed circuit boards is difficult to lower.

Furthermore, for digitization conducted at intermediate frequencies, high SN ratios (signal-to-noise ratios) have been required in recent years and this has led to the use of analog-to-digital converters using delta sigma modulation.

FIG. 9 shows an example of delta sigma modulators. In FIG. 9, reference numeral 121 denotes the input terminal of the delta sigma modulator, reference numeral 122 denotes a sampling circuit, reference numeral 123 denotes a subtracter, reference numeral 124 denotes a time discrete filter, reference numeral 125 denotes a quantizer, reference numeral 126 denotes a digital-to-analog converter, and reference numeral 127 denotes the output terminal of the delta sigma modulator.

In the delta sigma modulator having such a configuration, a signal X from the input terminal 121 is sampled by the sampling circuit 122 which conducts oversampling using a sampling frequency M·fs which is M times higher than a Nyquist frequency to produce a signal Xs. And further, a signal Ys obtained at the output terminal 127 is converted to an analog signal by the digital-to-analog converter 126 at the sampling frequency M·fs. Then the output signal of the digital-to-analog converter 126 is subtracted from the output signal Xs of the sampling circuit 122 by the subtracter 123. Furthermore, the output signal from the subtracter 123 is passed through the time discrete filter 124 having a transfer function H (Z) and then quantized by the quantizer 125, thereby the signal Ys is obtained at the output terminal 127. Through the use of the above configuration, such a sigma delta modulation operation is performed.

When an oversampling rate M set at a high value at the above delta sigma modulator, quantizing noise can be reduced and at the same time, the SN ratio can be heightened by virtue of noise shaping effect. Because of this, in systems which often require high SN ratios, delta sigma modulators have been used. In addition, when the oversampling rate can be set at a high value, the ratio of a passing band to a blocking band becomes high, which makes the design of an anti-aliasing filter easy. On account of this, in a case where an input signal with a low frequency has been used, a delta sigma AD converter in which sufficient oversampling was performed has been used. In that case, an intermediate frequency becomes high (for example, in FM radio receivers, 10.7 MHz), it becomes difficult to do oversampling, and therefore it has become difficult to select a high sampling frequency. As a result, the oversampling rate has lowered and a high-order low-pass filter has been required for sufficiently attenuating signals with frequencies which is up to half of an AD conversion frequency fₛ, which has made it difficult to design an anti-aliasing filter and to include the filter in an integrated circuit.

In radio receivers, frequency bands of input signals have been wide and differently modulated signals such as AM signals and FM signals have been supplied to them. And further, there is an increasing demand to correctly receive RF signals sent by broadcasting stations not only in Japan but in North America, Europe, and so on. On the other hand, as semiconductor technology progresses, digitalization moves forward, there is a demand to digitize signals at higher frequencies, and the digitization of signals at intermediate frequencies is being conducted energetically.

Therefore, it is assumed that there is a need to provide an anti-aliasing filter at a stage previous to the discretization of analog signals. In addition, with the discretization of digital signals at high-frequency regions, there is a demand for a wider dynamic range. This also means that the anti-aliasing filter is required to have a wider dynamic range, that is, a higher degree of precision and a high SN ratio.

To lessen a demand for the provision of a continuous time filter, it is preferable to select a sampling frequency which is sufficiently higher than a Nyquist frequency; however, together with a demand for discretization conducted at higher intermediate frequencies, it has become difficult to raise an oversampling rate. On account of this, as a high-precision anti-aliasing filter, an external passive-component filter (for example, a ceramic filter) has been heretofore used; but the use of such an external component has raised the cost of receiver production, and therefore it has been assumed that there is a need to include a high-precision anti-aliasing filter in an integrated circuit to reduce the cost. However, since such a high-precision is difficult to implement and a high order is required, it is difficult to secure a high SN ratio. In addition to this, in order to heighten the precision of the filter, much power must be consumed and hence, it has been difficult to include it in an integrated circuit. According to Non-Patent Reference 1 (“10.7-MHz IF-to-Baseband EA A/D Conversion System for AM/FM Radio Receiver”, IEEE Journal of Solid-State Circuits, Vol. 35, No. 12, December, 2000), in order to solve such a problem, an intermediate frequency is converted to a low intermediate frequency for a time and an oversampling rate is raised. However, this requires the use of an extra frequency mixer and makes many unwanted spectra occur.

### SUMMARY OF THE INVENTION

Therefore an object of the present invention is to implement an anti-aliasing filter which requires no extra frequency mixer, enables discretization at a sampling frequency which is not so high as compared with an intermediate frequency, has a wide dynamic range, a low power consumption, and a high degree of precision, and accommodates discretization at the intermediate frequency and to provide a low-cost high-performance receiver with reduced power consumption which can be fabricated by using such an anti-aliasing filter.

In order to solve the foregoing problems, the present inventors particularly focused on a frequency at which aliasing occurs and the relationship between the intermediate frequency generated by a frequency mixer and so on and the sampling frequency. As a result, in this invention, an anti-aliasing filter with a high SN ratio and a wide dynamic range is implemented while lightening a load on the anti-filter by removing the frequency at which aliasing occurs and frequencies around it through the use of, for example, a notch filter. And further, by using such an anti-aliasing filter, a low-cost low-power high-performance receiving system is provided.

A receiver according to a first aspect of the invention includes an amplifier which amplifies a RF input signal, a local oscillator which outputs a local oscillation signal, a frequency mixer which mixes the RF signal outputted from the variable gain amplifier and the local oscillation signal outputted from the local oscillator to give an intermediate-frequency signal, a band-pass filter which subjects the intermediate-frequency signal outputted from the frequency mixer to channel selection, an analog-to-digital converter which subjects an output signal from the band-pass filter to analog-to-digital conversion by using a predetermined sampling frequency, and an anti-aliasing filter which is provided at the previous stage of the analog-to-digital converter and which attenuates signals with frequencies which are higher and lower than a frequency which is an integral multiple of the sampling frequency by the intermediate frequency.

In this configuration, since the anti-aliasing filter attenuates signals with frequencies which are higher and lower than a frequency which is an integral multiple of the sampling frequency by the intermediate frequency, the anti-aliasing filter with a high degree of precision and a wide dynamic range is implemented to conduct discretization at the intermediate frequency and can be integrated into the receiver. As a result, it is possible to provide the low-cost low-power high-performance receiver.

In this aspect, it is preferable to use a delta sigma modulator as the analog-to-digital converter.

Further, the anti-aliasing filter is provided by using an active filter including, for example, plural notch filters and attenuates by desired values channel band frequencies which are higher and lower than a frequency which is an integral multiple of the sampling frequency by the intermediate frequency.

In this case, the anti-aliasing filter is provided to remove not only a single frequency but frequencies of unwanted channel bands which cause interference. Not all interference waves are brought about by the same communication system. Signals generated at televisions may bring about interference waves in radios and signals generated at cellular phones may bring about interference waves in televisions. Since channel bands vary among individual communication systems, frequency bands to be removed differ according to the types of interference waves.

Furthermore, it is preferable that the anti-aliasing filter be integrated into the identical integrated circuit together with the amplifier, the frequency mixer, and the local oscillator.

A receiver according to a second aspect of the invention includes an amplifier which amplifies an RF input signal, a local oscillator which outputs a local oscillation signal, a frequency mixer which mixes the RF signal outputted from the variable gain amplifier and the local oscillation signal outputted from the local oscillator to give an intermediate-frequency signal, a band-pass filter which has a sampling function and subjects the intermediate-frequency signal outputted from the frequency mixer to channel selection, and an anti-aliasing filter which is provided between the band-pass filter and the frequency mixer and attenuates signals with frequencies which are higher and lower than a frequency which is an integral multiple of a sampling frequency by the intermediate frequency.

In such a configuration, since the anti-aliasing filter attenuates signals with frequencies which are higher and lower than a frequency which is an integral multiple of the sampling frequency by the intermediate frequency, the anti-aliasing filter with a high degree of precision and a wide dynamic range is implemented to conduct discretization at the intermediate frequency and can be integrated into the receiver. As a consequence, it is possible to provide the low-cost low-power high-performance receiver.

In this aspect, the band-pass filter is provided by using, a switched capacitor filter. In addition, it is preferable that the sampling frequency used at the band-pass filter be four times higher than the intermediate frequency.

Further, the anti-aliasing filter is provided by using an active filter including plural notch filters and attenuates by desired values signals with channel band frequencies which are higher and lower than a frequency which is an integral multiple of the sampling frequency by the intermediate frequency.

Furthermore, since the amplifier amplifies plural RF input signals with different frequency bands and the band-pass filter changes the sampling frequency in response to the intermediate frequency, it is preferable to include a component which varies a frequency response according to input frequency bands.

In accordance with the invention, the anti-aliasing filter with a high degree of precision and a wide dynamic range is implemented to bring about discretization at the intermediate frequency and can be integrated into the receiver. And this makes it possible to provide the low-cost, low-power and high-performance receiver.

### BRIEF DESCRIPTION OF THE DRAWINGS

FIG. 1 is a block diagram of the configuration of a receiver according to a first embodiment of the present invention;

FIG. 2 is a block diagram of the configuration of a receiver according to a second embodiment of the invention;

FIG. 3 is a block diagram of the configuration of a conventional receiver which digitizes a base band signal;

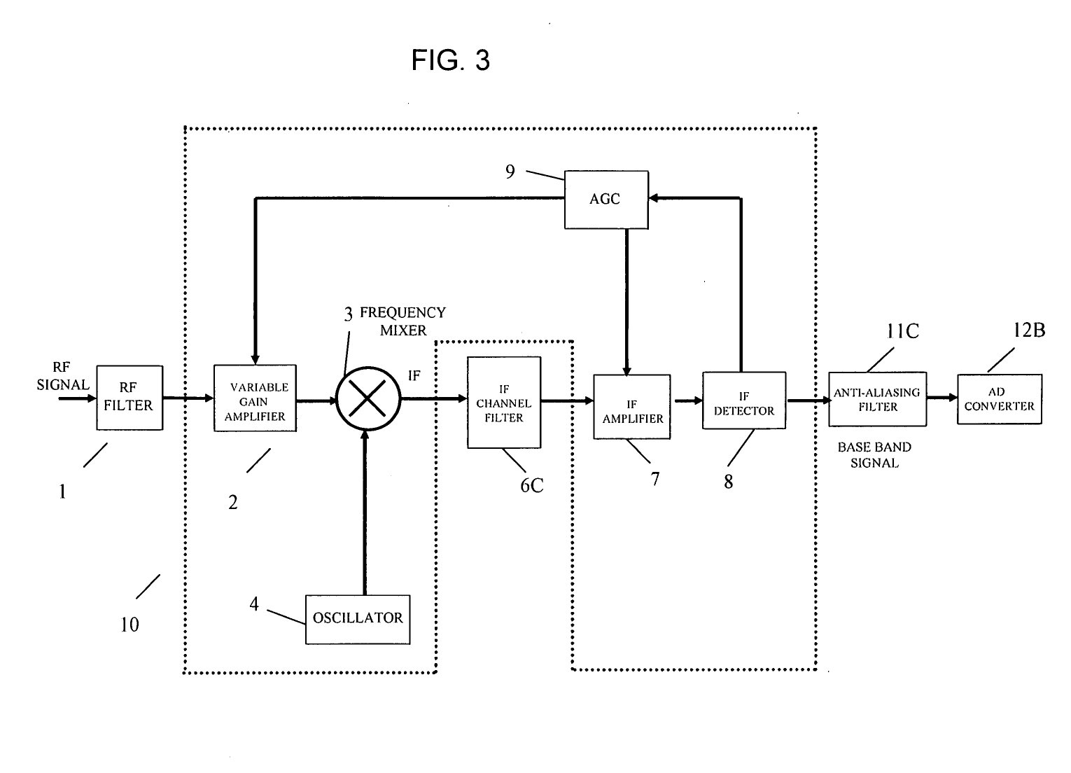

FIG. 4 is a block diagram of the configuration of a conventional receiver which digitizes an IF signal;

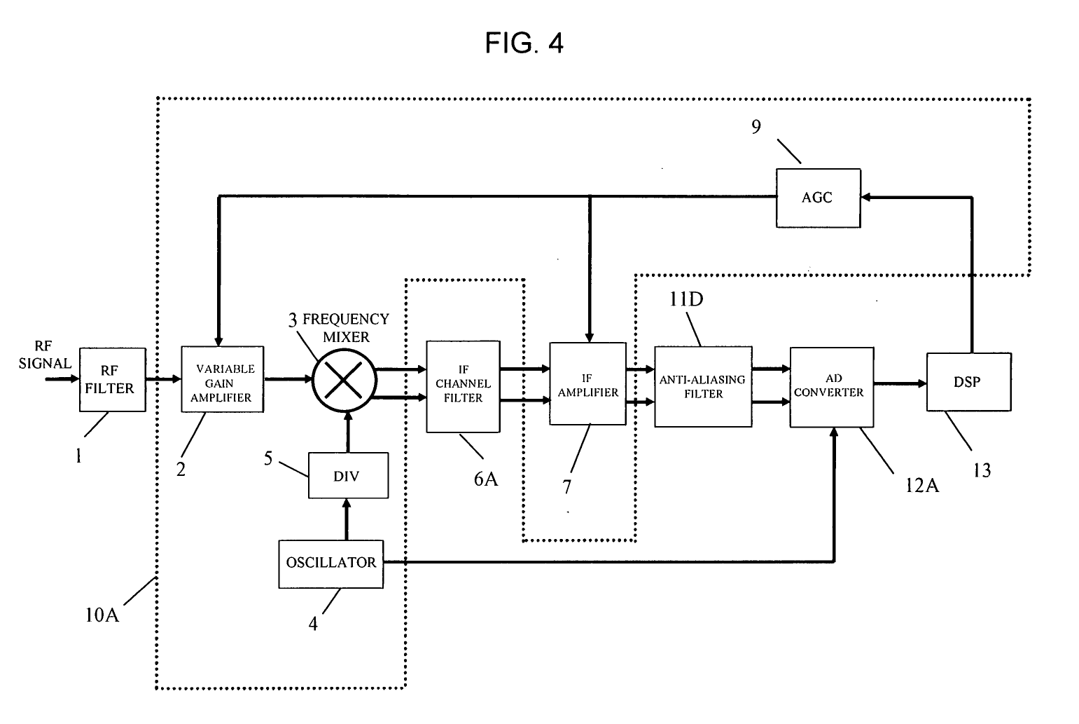

FIG. 5 is a block diagram of the configuration of an IF digital receiver into which a desired wave and interference waves are simultaneously fed;

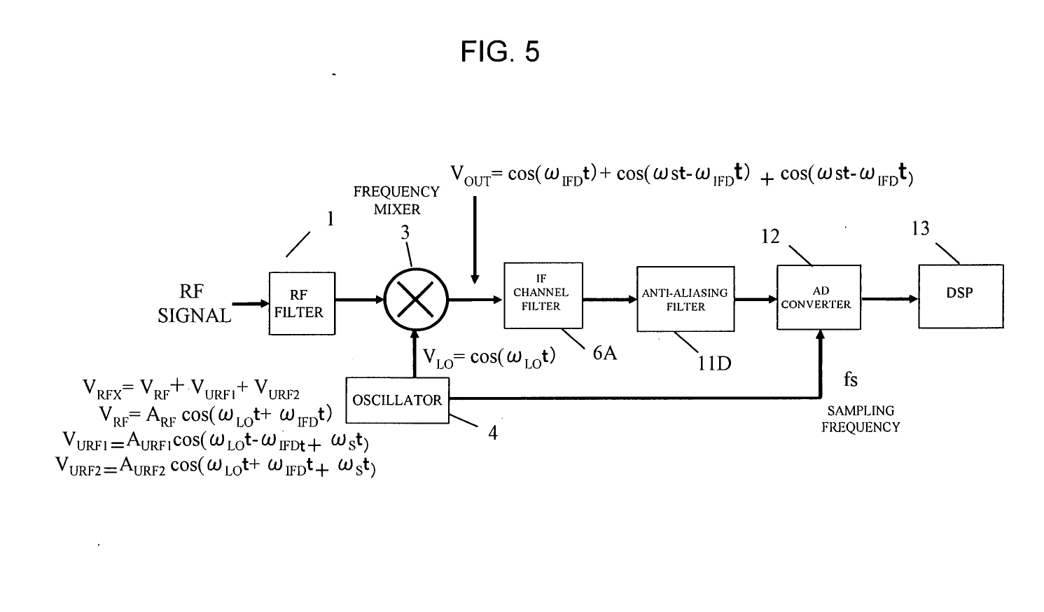

FIG. 6 is a graph of the frequency spectrum of the IF digital receiver into which the desired wave and the interference waves are simultaneously fed;

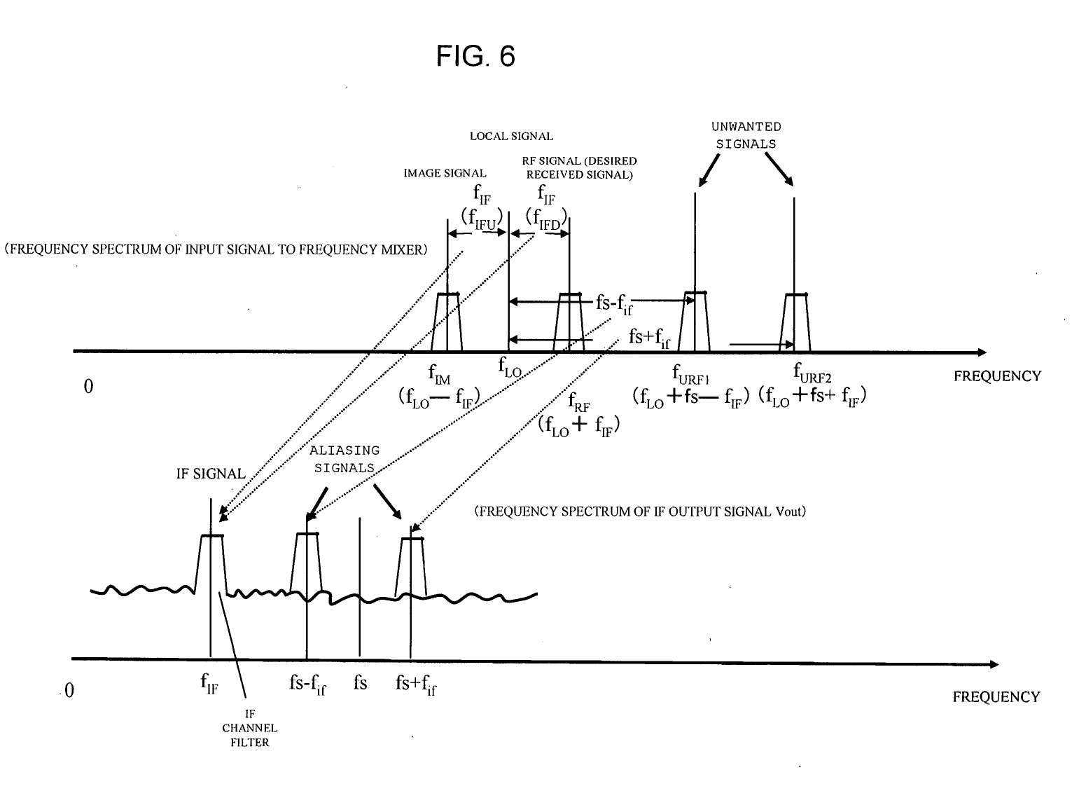

FIGS. 7A and 7B are characteristic diagrams showing the characteristics of a conventional anti-aliasing filter;

FIGS. 8A and 8B are characteristic diagrams showing the characteristics of an anti-aliasing filter according to the invention;

FIG. 9 is a block diagram of an example of a delta sigma converter;

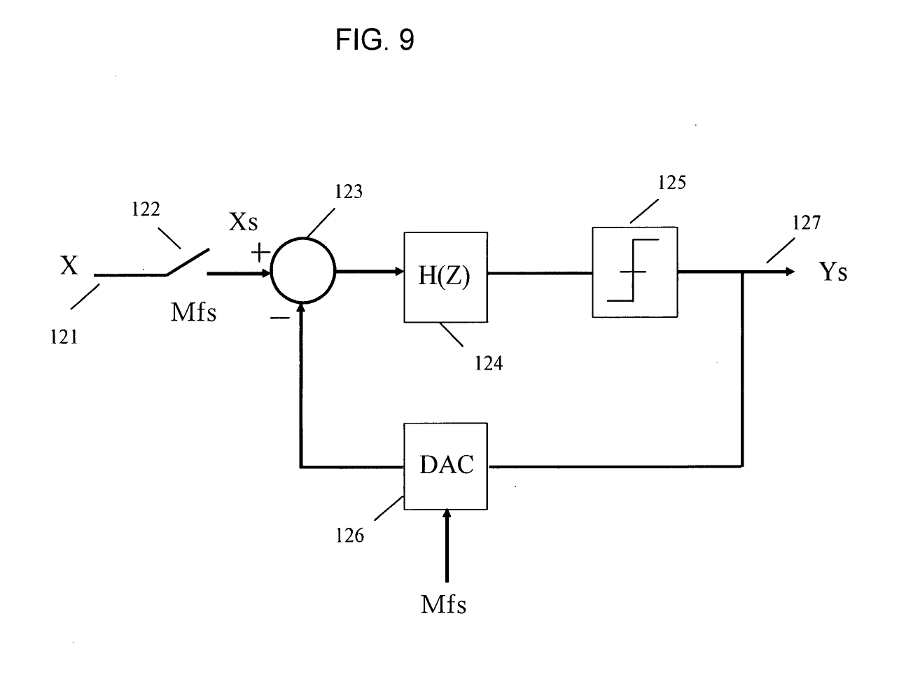

FIG. 10 is a block diagram of an example of a low-pass notch filter; and

FIG. 11 is a graph showing an example of the frequency characteristics of the low-pass notch filter.

### DESCRIPTION OF THE EXEMPLARY EMBODIMENTS

Receivers according to embodiments of the present invention will be described below with reference to the drawings.

### First Embodiment

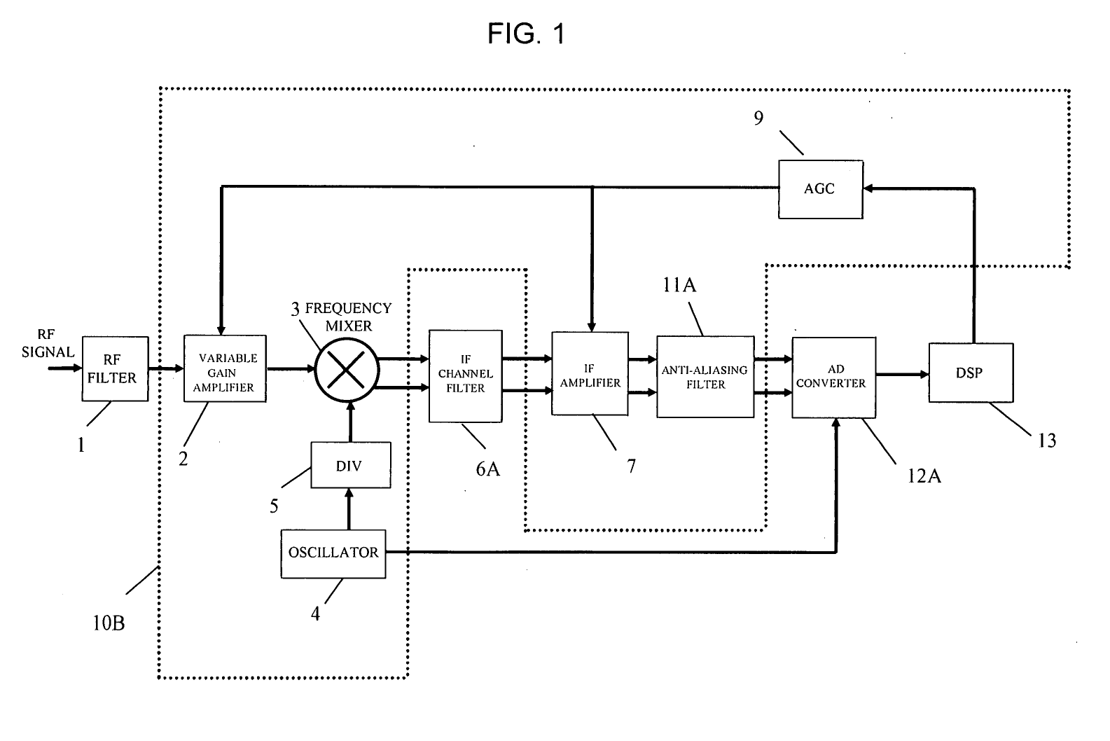

FIG. 1 is a block diagram of an AM/FM receiver according to a first embodiment of the invention. In the following, an explanation of the AM/FM receiver according to the first embodiment will be made with reference to the figure. In FIG. 1, an input RF signal is frequency-selected by a RF filter 1, passes through a variable gain amplifier 2, and is mixed with a local oscillation signal from an oscillator 4 by a frequency mixer 3 to produce an intermediate-frequency signal. The output signal of the frequency mixer 3 is fed to an IF channel filter (intermediate-frequency band filter) 6A as a band-pass filter and only a desired IF signal is selected. An output of the IF channel filter 6A is amplified by an IF amplifier 7 and fed to an AD converter 12A through an anti-aliasing filter 11A.

An output of the AD converter 12A is converted to a base band signal by a digital signal processor 13 and the output signal subjected to level detection is supplied to an automatic gain control circuit 9. As a result, control voltages are fed to the variable gain (RF) amplifier 2 and the IF amplifier 7 such that the level of the base band signal becomes constant, and therefore gain is controlled.

In this case, the frequency of the intermediate-frequency signal can be made constant by changing a frequency dividing rate at a frequency divider 5. For example, in RF signals for use in FM radio broadcasting performed in Japan, channels are set from 76 MHz to 91 MHz in 200 kHz intervals. To set the intermediate frequency f_{IF} at 10.7 MHz, a local frequency is from 65.3 MHz to 80.3 MHz. Take, for example, a case where a sampling frequency fs used at the AD converter 12A is 41.6 MHz. In this case, when a signal with a frequency of 96.2 MHz to 111.2 MHz which is higher than the local frequency by fs−f_{IF}=30.9 MHz is included in an input RF signal, a signal with a frequency of 30.9 MHz appears as an output signal of the frequency mixer 3. When sampling has been carried out by using a frequency of 41.6 MHz, a frequency component of 10.7 MHz appears after the sampling, and therefore aliasing noise occurs.

Since FM sound signal carriers for TV broadcasting are present in a frequency band from 95.75 MHz in increments of 6 MHz, such aliasing noise occurs. Therefore, by removing signals with frequencies around a frequency of fs−f_{IF}=30.9 MHz from the output signal of the frequency mixer 3 in advance, aliasing noise does not occur. In contrast, there is no need to sufficiently attenuate the input signal to a frequency of fs/2, and therefore only frequency components to be aliased can be attenuated.

Likewise, when any signal with a frequency of 128.3 MHz to 143.3 MHz which is higher than the local frequency by fs+f_{IF}=52.3 MHz is included in an input RF signal, aliasing noise occurs as in the case described above. Therefore the input signal can be attenuated in advance by the filter before sampling is carried out using the sampling frequency fs.

Furthermore, as in these cases, signals with frequencies of 2fs−f_{IF}=72.5 MHz and 2fs+f_{IF}=93.9 MHz, that is, signals with frequencies of nfs−f_{IF} Hz and nfs+f_{IF} Hz (n is any given integer) can be attenuated before sampling. As a result, a load on the anti-aliasing filter is lightened, the inclusion of the anti-aliasing filter is easily done, and the attenuation of frequencies which result in aliasing noise in easily secured.

Reference alphanumeric 10B denotes an integrated block and in this embodiment, the anti-aliasing filter 11A is also included therein.

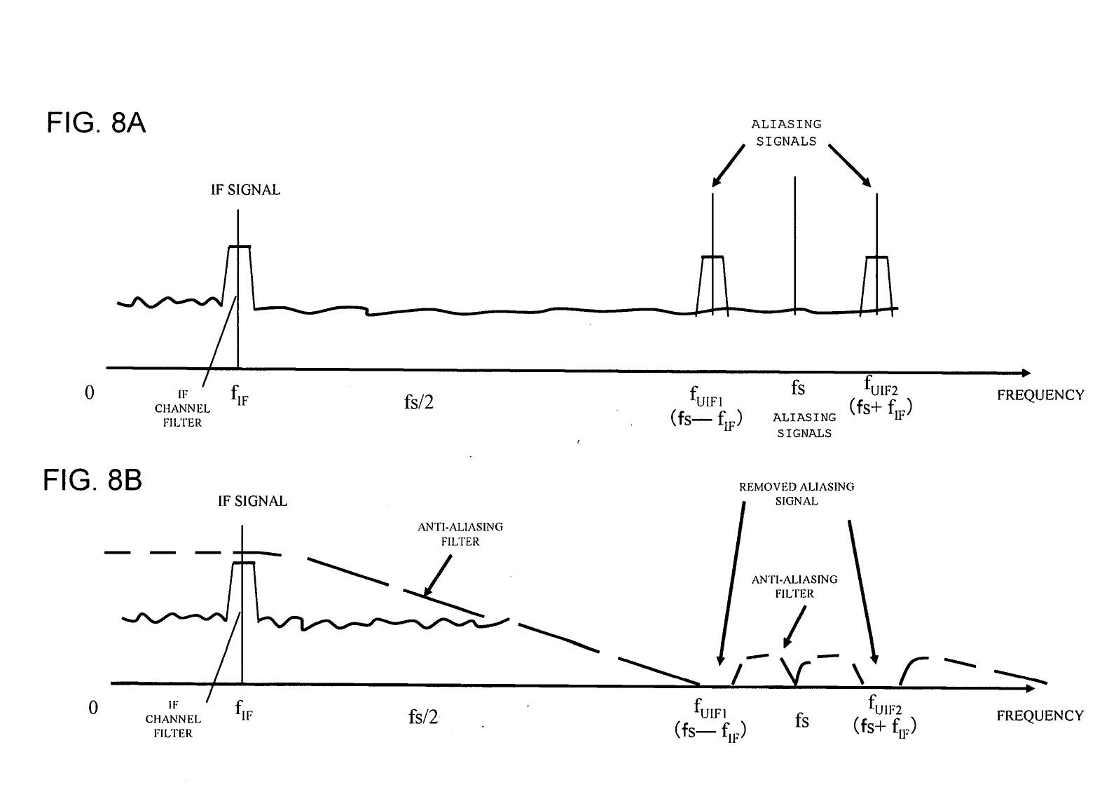

FIG. 8A is a graph showing the frequency characteristics of the output of the IF channel filter 6A. In FIG. 8B, the frequency characteristics of the anti-aliasing filter 11A according to the invention is indicated by a broken line and the frequency characteristics of the output of the anti-aliasing filter 11A is indicated by a solid line. It is apparent from FIG. 8B that plural notch filters are included in order to remove two aliasing signals with frequencies of f_{UIF1} and f_{UIF2}. The reason why the plural notch filters are included is that the use of a single notch filter may bring about an insufficient removal of a signal with a certain frequency band. That is, by providing plural notch filters, the power of interference waves to be removed is suppressed below a certain value. In FIG. 8B, an example of an anti-aliasing filter with three notch filters is indicated.

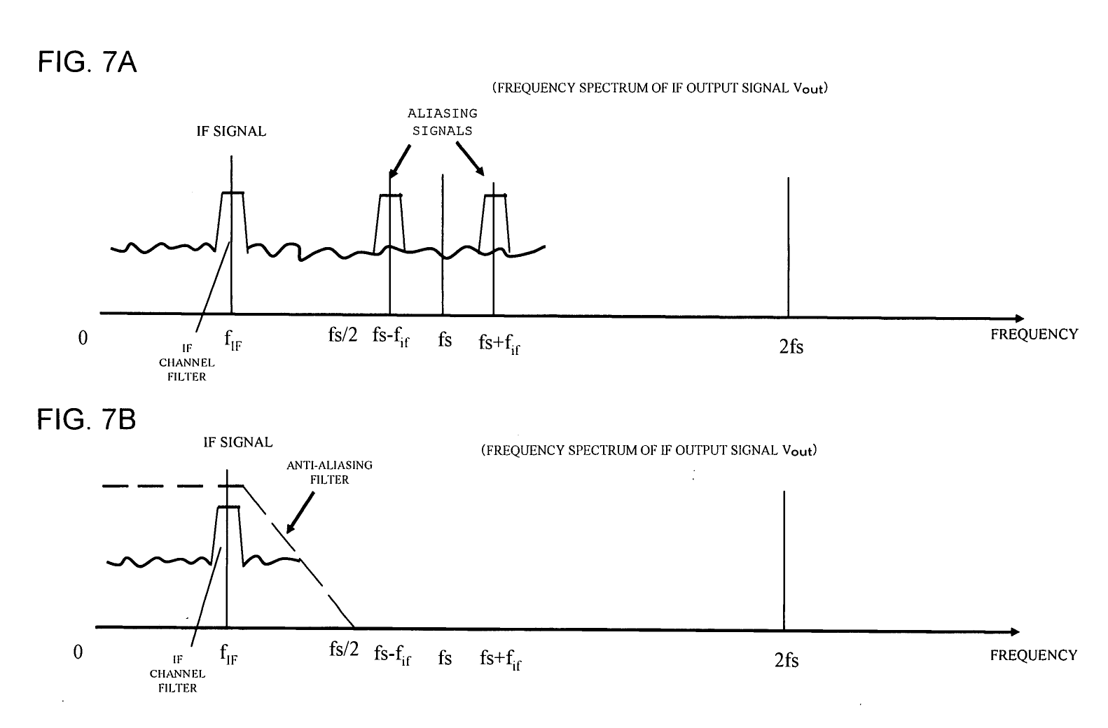

The anti-aliasing filters 11C and 11D of the conventional receivers described earlier are external filters which attenuate the sampling frequency to its half level. In contrast, the anti-aliasing filter 11A according to the invention is a filter which removes interference waves around the IF band which are considered to be likely to occur in light of the way the IF frequency is generated through the use of notch filters. As can be seen from FIGS. 7B and 8B, the anti-aliasing filter 11A according to the invention and the external passive filter are different from each other in frequency characteristics.

In the following, the explanation of notch filters will be made. Notch filters are able to remove only frequencies if signals. When plural interference waves are present and interference waves have certain frequency bands, such interference waves can be effectively removed by using plural notch filters.

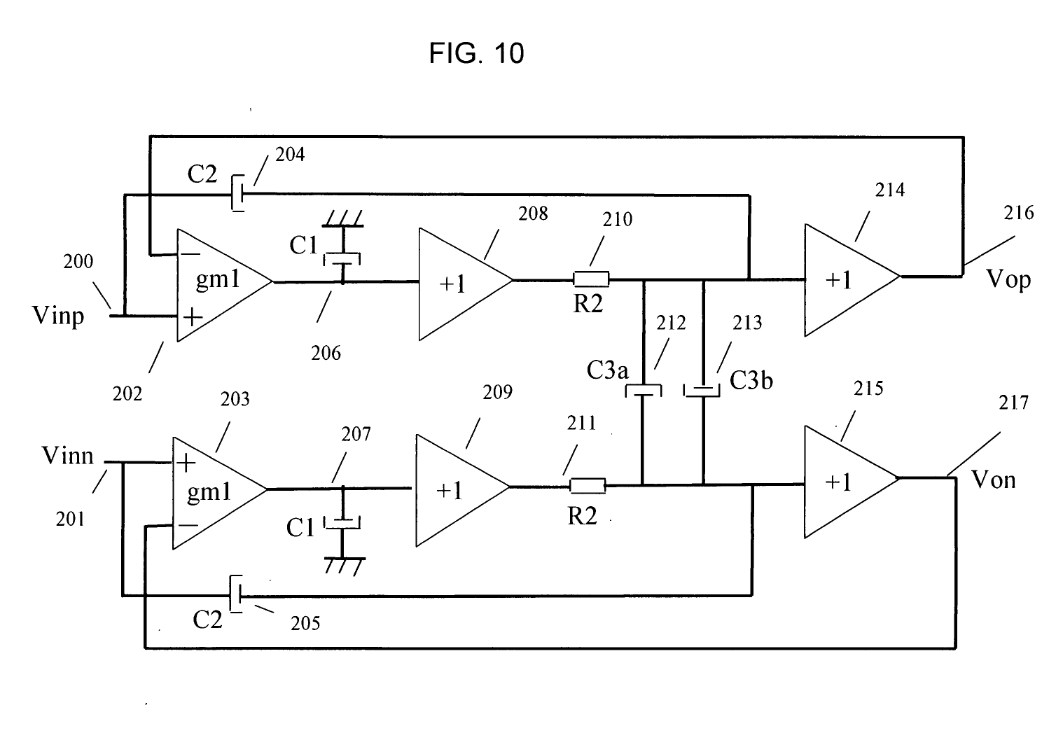

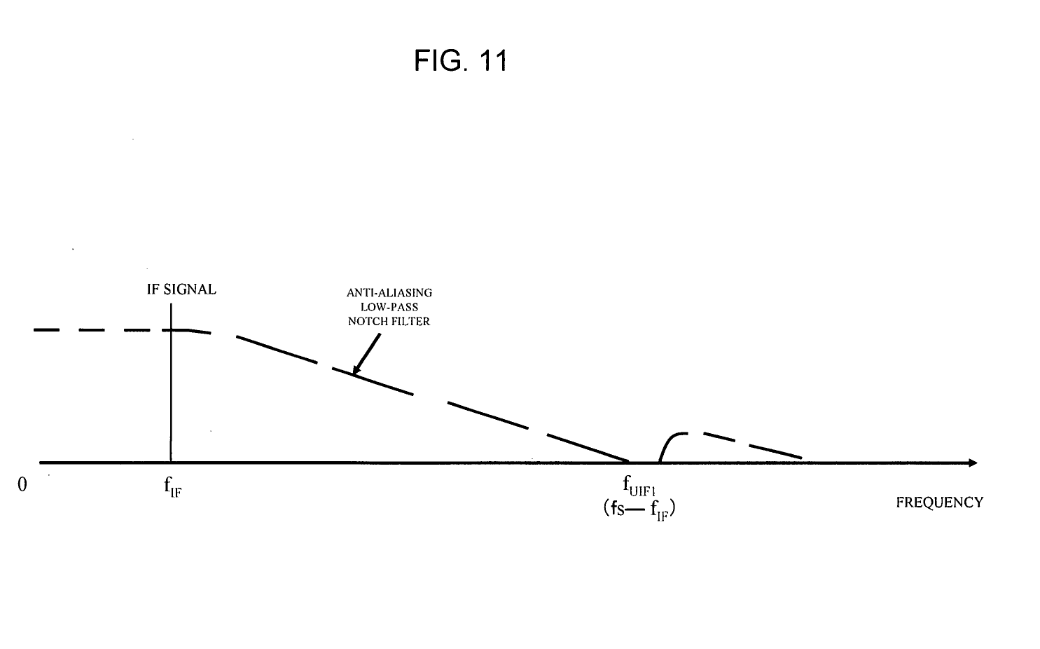

One example of notch filters is shown in FIG. 10. In FIG. 10, a positive-phase input Vinp is fed to an input terminal 200, and a negative-phase input Vinn is fed to a negative-phase input terminal 201. Then the positive-phase input Vinp and the negative-phase input Vinn are provided to the positive-phase input terminals of transconductance amplifiers 202 and 203 respectively. A positive-phase output Vop which appears at appositive-phase output terminal 216 is fed to the negative-phase input terminal of the transconductance amplifier 202, and a negative-phase output Von which appears at a negative-phase output terminal 217 is fed to the negative-phase input terminal of the transconductance amplifier 203. Integrating capacitors 206 and 207 are added to the outputs of the transconductance amplifiers 202 and 203 respectively. The output signals of the transconductance amplifiers 202 and 203 pass through voltage buffers 208 and 209 and resistors 210 and 211 respectively. Then the output signals are added to each other at capacitors 212 and 213 (C3a and C3b) and are also simultaneously added to the positive-phase input 200 and the negative-phase input 201 through capacitors 204 and 205, following which results are outputted through buffers 214 and 215. The transfer function H(s) of the filter is as follows:
H(s)={C2/(C2+4C3)}*{(S²+gm1/(2C1*C2*R2)}/{S²+S/((C2+4C3)*R2)+gm1/(C1*(C2+4C3)*R2}
where gm1's are the conductance values of the transconductance amplifiers 202 and 203, C1's are the capacitance values of the capacitors 206 and 207, R2's are the resistance values of the resistors 210 and 211, C3's are the summed capacitance values of the capacitors 212(C3a) and 213(C3b), and C2's are the capacitance values of the capacitors 204 and 205. Such a filter acts as a low-pass notch filter with a notch frequency ωn=1/(C1*C2*R2/gm1)^{1/2}, a characteristic frequency ωO=1/{C1*(C2+4C3)*R2/gm1}^{1/2}, and a selectivity Q={C2+4C3}/C1*(R2*gm1)}^{1/2} An example of the frequency characteristics of the low-pass notch filter is indicated in FIG. 11.

### Second Embodiment

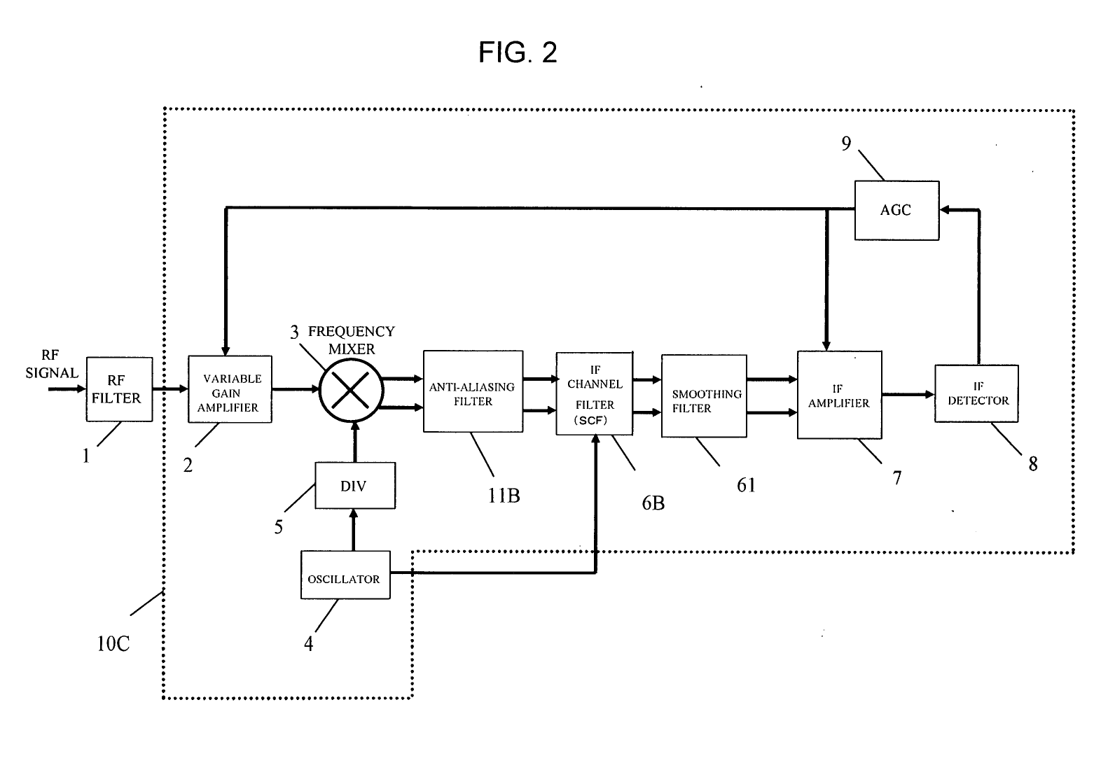

FIG. 2 is a block diagram of a receiver according to a second embodiment of the present invention. When a sampling circuit such as a switched capacitor (SCF) circuit is used as an IF channel filter as well, the same description as that presented above holds true for the prevention of aliasing noise.

In the second embodiment, a case is taken where the sampling circuit such as the switched capacitor circuit is used as the IF channel filter 6B in order to deal with aliasing noise.

The receiver according to the second embodiment is capable of receiving various signals having different frequency bands such as AM signals and FM signals. Intermediate frequencies vary among frequency bands, and therefore the variable gain amplifier 2 amplifies plural RF input signals having different frequency bands.

In FIG. 2, the receiver is indicated in which the IF channel filter 6B is formed as a switched capacitor circuit having a sampling function. Being required to have high selectivity, the IF channel filter is generally formed by using an external passive component mainly using a ceramic filter. On the other hand, a switched capacitor filter controlled with a clock frequency can be formed as a high-precision filter and is, therefore, suitable for being used as an IF channel filter. And further, a smoothing filter 61 is provided to a stage subsequent to the IF channel filter 6B. The output signal of the smoothing filter 61 is sent to the IF amplifier 7.

Furthermore, a sampling clock signal is sent from the oscillator 4 to the IF channel filter 6B. Therefore the frequency of the sampling clock signal changes at the IF channel filter 6B in response to a change in the intermediate frequency. That is, when the frequency band of the signal (in a band-pass filter, a 3-dB narrower frequency band width) has changed concurrently with a change in the intermediate frequency, the characteristics of the filter is changed so as to match the frequency band of the signal. Such a configuration corresponds to a means in which a frequency response can be varied according to the frequency band of an input by changing a sampling frequency in response to an intermediate frequency.

The configuration and operation of this embodiment other than the above are the same as those described in the conventional art and the first embodiment.

In this case, the intermediate frequency becomes considerably high at the switched capacitor circuit. For example, it is assumed that when a frequency of 450 KHz was selected as an intermediate frequency, a frequency of 1.8 MHz which is four times higher than the intermediate frequency has been selected as a clock frequency. At this point of time, as the clock frequency is heightens, the load on the anti-aliasing filter 11B is lightened. However, in terms of the frequency characteristics (gain-bandwidth product) of an operational amplifier used at the switched capacitor circuit, a frequency is selected which is five to twenty times higher than the clock frequency. Because of this, when the selected clock frequency is high, the design of the operational amplifier becomes difficult and much electric current is consumed; therefore, the clock frequency cannot be heightened much. In contrast, when the selected clock frequency is low, the design of the anti-aliasing filter 11B becomes difficult. Therefore, as described above, the frequency is selected which is about four times higher than the intermediate frequency. In this case as well, as in the case of the AD converter of FIG. 1, a frequency at which aliasing is likely to occur can be selected as a RF signal in advance, and then the signal can be attenuated through the use of the filtering function of the anti-aliasing filter 11B which is the previous stage of the IF channel filter 6B provided as the switched capacitor circuit.

Examples of the intermediate frequency and bandwidth set when switching between plural frequency bands is performed are as follows: for example, in the AM band, the intermediate frequency is 450 kHz and the bandwidth is 6 kHz and in the FM band, the intermediate frequency is 550 kHz and the bandwidth is 200 kHz.

As a result, the load on the anti-aliasing filter 11B is lightened, thereby power consumption can be reduced and the high-precision anti-aliasing filter 11B can be implemented.

It should be noted that the present invention is applicable to configurations in which the reception of a single frequency band is performed. And furthermore, the invention is not limited to AM/FM radio receivers but applicable to other various receivers.

### INDUSTRIAL APPLICABILITY

According to the present invention described above, when an intermediate frequency is subjected to analog-to-digital conversion and discretization is conducted by using a switched capacitor circuit in a receiving system such as a radio receiver, a high-precision anti-aliasing filter is implemented and power consumption of the filter can be reduced. As a result, the anti-aliasing filter can be included in an integrated circuit without the use of any external filter and the anti-aliasing filter having low power consumption and a high degree of precision can be implemented in response to various input signal frequencies. Therefore, a low-cost high-performance receiving system can be provided and the anti-aliasing filter is also applicable to other receiving systems.

1. A receiver comprising:
an amplifier which amplifies a RF input signal;
a local oscillator which outputs a local oscillation signal;
a frequency mixer which mixes the RF signal from the amplifier and the local oscillation signal from the local oscillator to produce an intermediate-frequency signal;
a band-pass filter which subjects the intermediate-frequency signal from the frequency mixer to channel selection;
an analog-to-digital converter which subjects an output signal from the band-pass filter to analog-to-digital conversion by using a predetermined sampling frequency; and
an anti-aliasing filter which is provided at a stage previous to the analog-to-digital converter and attenuates signals with frequencies which are higher and lower than a frequency which is an integral multiple of the sampling frequency by the intermediate frequency.

2. The receiver according to claim 1, wherein the analog-to-digital converter is a delta sigma converter.

3. The receiver according to claim 1, wherein the anti-aliasing filter attenuates by desired values channel band frequencies which are higher and lower than a frequency which is an integral multiple of a sampling frequency by the intermediate frequency.

4. The receiver according to claim 1, wherein the anti-aliasing filter is provided by using an active filter including plural notch filters and attenuates by desired values channel band frequencies which are higher and lower than a frequency which is an integral multiple of a sampling frequency by the intermediate frequency.

5. The receiver according to claim 1, wherein the anti-aliasing filter is integrated into the identical integrated circuit together with the amplifier, the frequency mixer, and the local oscillator.

6. A receiver comprising
an amplifier which amplifiers a RF input signal;
a local oscillator which outputs a local oscillation signal;
a frequency mixer which mixes the RF signal from the variable gain amplifier and the local oscillation signal from the local oscillator to produce an intermediate-frequency signal;
a band-pass filter which has a sampling function and subjects an intermediate-frequency signal from the frequency mixer to channel selection; and
an anti-aliasing filter which is provided between the band-pass filter and the frequency mixer and attenuates signals with frequencies which are higher and lower than a frequency which is an integral multiple of the sampling frequency by the intermediate frequency.

7. The receiver according to claim 6, wherein the band-pass filter is provided by using a switched capacitor filter.

8. The receiver according to claim 6, wherein a sampling frequency for the band-pass filter is four times as high as the intermediate frequency.

9. The receiver according to claim 6, wherein the anti-aliasing filter is provided by using an active filter including plural notch filters and attenuates by desired values signals with channel band frequencies which are higher and lower than a frequency which is an integral multiple of a sampling frequency by the intermediate frequency.

10. The receiver according to claim 6, wherein since the amplifier amplifies plurals RF input signal with different frequency bands and the band-pass filter changes the sampling frequency in response to the intermediate frequency, a component is provided which varies a frequency response according to input frequency bands.
